(19) United States
(12) Patent Application Publication
(10) Pub. No.: US 2017/0371664 A1
(43) Pub. Date: Dec. 28, 2017

(54) PROGRAM INFORMATION GENERATION SYSTEM, METHOD, AND COMPUTER PROGRAM PRODUCT

(71) Applicant: Kabushiki Kaisha Toshiba, Minato-ku (JP)

(72) Inventors: Mayuko KOEZUKA, Ota (JP); Hidenori Matsuzaki, Fuchu (JP); Akira Kuroda, Yokohama (JP); Nobuaki Tojo, Yokohama (JP)

(73) Assignee: Kabushiki Kaisha Toshiba, Minato-ku (JP)

(21) Appl. No.: 15/440,635

(22) Filed: Feb. 23, 2017

(30) Foreign Application Priority Data
Jun. 23, 2016 (JP) 2016-124547

(51) Int. Cl. G06F 9/30; G06F 9/38

(52) U.S. Cl. CPC G06F 9/30145; G06F 9/30021; G06F 9/3836

(57) ABSTRACT

A program information generation system includes circuitry configured to acquire a program and operation information, the program including a plurality of instruction codes including a start instruction code for starting a critical section and an end instruction code for ending the critical section, the operation information indicating an execution order of the plurality of instruction codes; identify the instruction code included in a first section corresponding to the critical section from the operation information, on the basis of the start instruction code, the end instruction code, and the operation information; determine a second section, corresponding to the first section, within the program on the basis of the instruction code included in the first section; and generate classification information for allowing specification of the instruction code included in the critical section or the instruction code included in a non-critical section, on the basis of the second section.

### CROSS-REFERENCE TO RELATED APPLICATIONS

This application is based upon and claims the benefit of priority from Japanese Patent Application No. 2016-124547, filed on Jun. 23, 2016; the entire contents of which are incorporated herein by reference.

### FIELD

Embodiments described herein relate generally to a program information generation system, method, and computer program product.

### BACKGROUND

A system that displays and analyzes operation information (an execution trace) indicating the execution order of processes of a program (software) is used as a tool for program testing. There is, for example, a system that displays an execution timing of a non-interrupt process and an execution timing of an interrupt process on the same time axis.

In order to prevent a failure occurring due to, for example, the sharing of a resource (such as memory) when a program is constructed, a critical section where an interrupt process is disabled may be set. Work such as the development, improvement, and repair of the program may require the acquisition and verification of information on the critical section. To perform such a verification correctly, it is desired to acquire the information on the critical section not only from an operation information level but also from a program level.

According to the known system, the location of occurrence of an interrupt process is displayed on the operation information. Accordingly, the location of occurrence of the interrupt process can be specified on the operation information level. However, the location of the critical section, a relationship between the critical section and the location of occurrence of the interrupt process, and the like cannot be verified on the program level.

### BRIEF DESCRIPTION OF THE DRAWINGS

FIG. 1 is a diagram illustrating a functional configuration of a program information generation system according to a first embodiment;

FIG. 2 is a diagram illustrating a hardware configuration of the program information generation system according to the first embodiment;

FIG. 3 is a diagram illustrating an internal configuration of an information processing terminal and a server according to the first embodiment;

FIG. 4 is a flowchart illustrating the flow of processes of the program information generation system according to the first embodiment;

FIG. 5 is a diagram illustrating a source code and a program according to the first embodiment;

FIG. 6 is a diagram illustrating the program and operation information according to the first embodiment;

FIG. 7 is a diagram illustrating classifications of instruction codes included in the program according to the first embodiment;

FIG. 8 is a diagram illustrating classification information according to a first example of the first embodiment;

FIG. 9 is a diagram illustrating classification information according to a second example of the first embodiment;

FIG. 10 is a diagram illustrating classifications of instruction codes included in a program and classification information according to a second embodiment;

FIG. 11 is a diagram illustrating a functional configuration of a program information generation system according to a third embodiment;

FIG. 12 is a flowchart illustrating the flow of processes of the program information generation system according to the third embodiment;

FIG. 13 is a diagram illustrating a source code and a program according to the third embodiment;

FIG. 14 is a diagram illustrating the program and operation information according to the third embodiment;

FIG. 15 is a diagram illustrating classifications of instruction codes included in the program and classification information according to a first example of the third embodiment;

FIG. 16 is a diagram illustrating classifications of instruction codes included in the program and classification information according to a second example of the third embodiment;

FIG. 17 is a diagram illustrating classifications of instruction codes included in the program and classification information according to a third example of the third embodiment;

FIG. 18 is a diagram illustrating a functional configuration of a program information generation system according to a fourth embodiment;

FIG. 19 is a diagram illustrating a display image according to a first example of the fourth embodiment;

FIG. 20 is a diagram illustrating a display image according to a second example of the fourth embodiment;

FIG. 21 is a diagram illustrating a display image according to a third example of the fourth embodiment;

FIG. 22 is a diagram illustrating a display image according to a fourth example of the fourth embodiment;

FIG. 23 is a diagram illustrating a display image according to a fifth example of the fourth embodiment;

FIG. 24 is a diagram illustrating a display image according to a sixth example of the fourth embodiment;

FIG. 25 is a diagram illustrating a display image according to a seventh example of the fourth embodiment;

FIG. 26 is a diagram illustrating a display image according to an eighth example of the fourth embodiment;

FIG. 27 is a diagram illustrating a display image according to a ninth example of the fourth embodiment; and

FIG. 28 is a diagram illustrating a display image according to a tenth example of the fourth embodiment.

### DETAILED DESCRIPTION

### First Embodiment

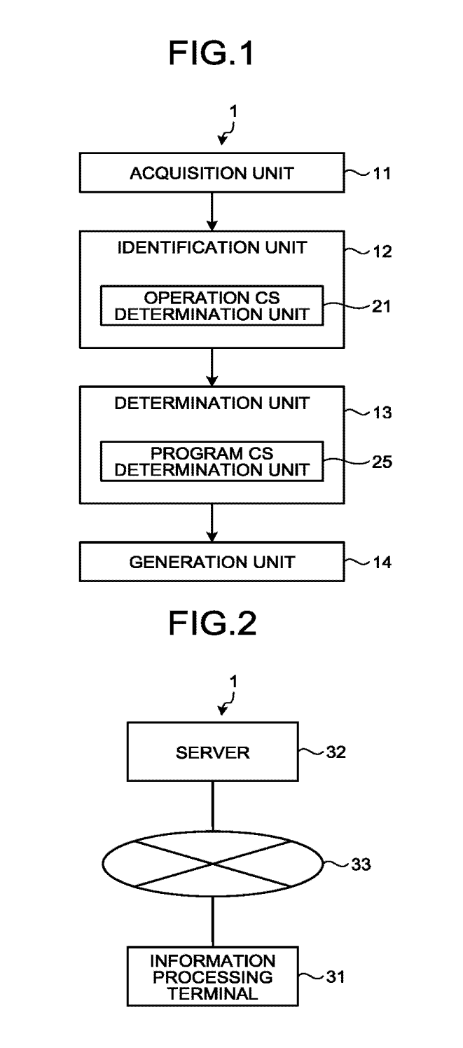

FIG. 1 is a diagram illustrating a functional configuration of a program information generation system 1 according to a first embodiment. The program information generation system 1 includes an acquisition unit 11, an identification unit 12, a determination unit 13, and a generation unit 14.

FIG. 2 is a diagram illustrating a hardware configuration of the program information generation system 1 according to the first embodiment. The program information generation system 1 of this example includes an information processing terminal 31, a server 32, and a network 33. The information processing terminal 31 can be a PC (Personal Computer), a tablet, a smartphone, or the like that is used by a user. The server 32 can be a server computer or the like that is managed by a manager of the program information generation system 1. The information processing terminal 31 and the server 32 are connected to each other via the network 33 such as the Internet or a LAN (Local Area Network). In FIG. 2, one information processing terminal 31 and one server 32 are described. However, the number of either or both of the information processing terminal 31 and the server 32 may be two or more.

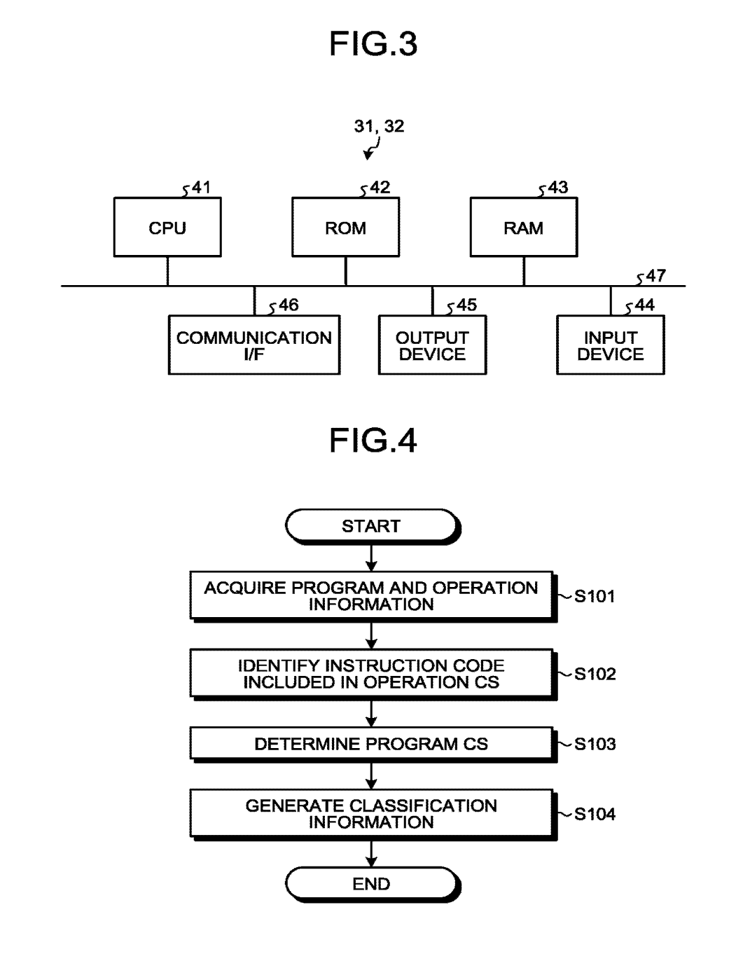

FIG. 3 is a diagram illustrating an internal configuration of the information processing terminal 31 and the server 32 according to the first embodiment. The information processing terminal 31 and the server 32 include circuitry such as a CPU (Central Processing Unit) 41, a ROM (Read Only Memory) 42, a RAM (Random Access Memory) 43, an input device 44, an output device 45, a communication I/F (Interface) 46, and an a bus 47. The CPU 41 performs a predetermined arithmetic process, using the RAM 43 as a working area, in accordance with a control program stored in the ROM 42 or the like. The input device 44 is a device for inputting information from the outside, and is, for example, a keyboard, a mouse, and a touchscreen. The output device 45 is a device for outputting internally generated information to the outside, and is, for example, a display and a printer. The communication I/F 46 is a device that enables transmission and receipt of information to and from an external apparatus via the network 33.

The functional units illustrated in FIG. 1 are described below. The acquisition unit 11 acquires a program targeted for testing and operation information indicating the execution order of a plurality of instruction codes included the program. The program according to the embodiment includes a start instruction code that starts a critical section and an end instruction code that ends the critical section. The critical section is a section where the occurrence of an interrupt process is disabled or should be disabled, and is a portion where a problem such as data corruption is highly likely to occur due to concurrent accesses to one resource (such as memory) upon, for example, execution of a plurality of processes. The acquisition unit 11 is configured using, for example, the CPU 41, the control program, a logic IC (Integrated Circuit), and the RAM 43. “Acquisition” here includes the receipt of data from the outside, and internal generation of data. In other words, the program and the operation information may be generated by a system (apparatus) other than the program information generation system 1, or may be generated in the program information generation system 1. A method for generating the program and the operation information is not particularly limited. The program and the operation information may be generated using a known or novel technology as appropriate. “Program” in the embodiment indicates a program targeted for testing by the program information generation system 1. “Control program” indicates a program to control the program information generation system 1.

The identification unit 12 includes an operation critical section (CS) determination unit 21. The operation critical section determination unit 21 determines an operation critical section (first section) being a critical section on an operation information level, on the basis of the start instruction code, the end instruction code, and the operation information. The identification unit 12 identifies one or more instruction codes included in the operation critical section. The identification unit 12 is configured using, for example, the CPU 41, the control program, the logic IC, and the RAM 43.

The determination unit 13 includes a program critical section (CS) determination unit 25. The program critical section determination unit 25 determines a program critical section (second section) being a critical section on a program level, the program critical section corresponding to the operation critical section, on the basis of the instruction code included in the operation critical section. The determination unit 13 is configured using, for example, the CPU 41, the control program, the logic IC, and the RAM 43.

The generation unit 14 generates classification information that indicates which of a plurality of instruction codes included in the program is included in the critical section, in other words, allows the specification of an instruction code included in the critical section or an instruction code included in a non-critical section being a section other than the critical section, on the basis of the program critical section. The generation unit 14 is configured using, for example, the CPU 41, the control program, the logic IC, and the RAM 43.

FIG. 4 is a flowchart illustrating the flow of processes of the program information generation system 1 according to the first embodiment. Firstly, the acquisition unit 11 acquires the program and the operation information (S101). The identification unit 12 then determines the operation critical section being the critical section on the operation information level with the function of the operation critical section determination unit 21, and identifies an instruction code included in the operation critical section from the operation information (S102). The determination unit 13 then determines the program critical section being the critical section on the program level on the basis of the identified instruction code with the function of the program critical section determination unit 25 (S103). The generation unit 14 then generates the classification information on the basis of the program critical section (S104).

The above configuration allows the generation of the classification information including program-level information on the critical section.

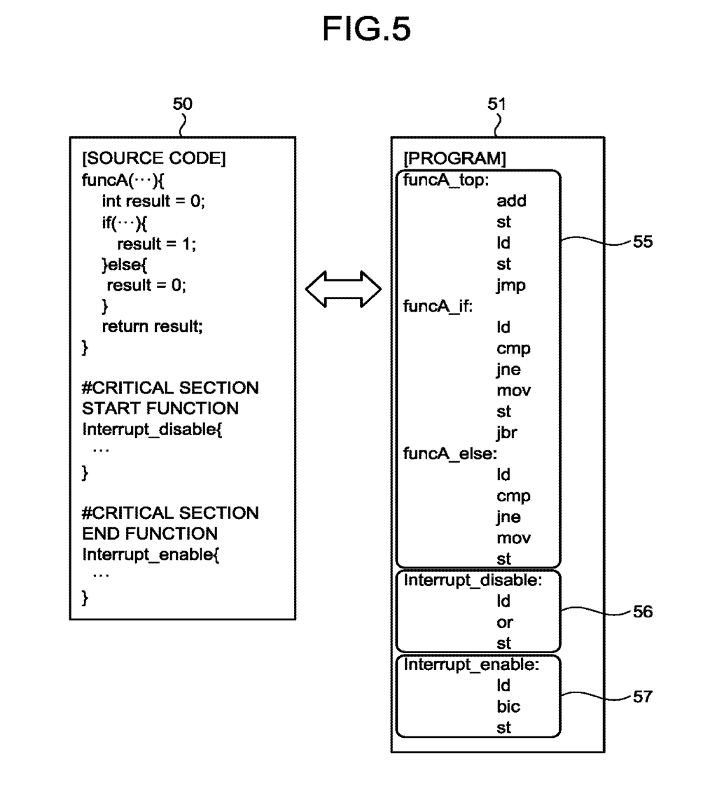

FIG. 5 is a diagram illustrating a source code 50 and a program 51 according to the first embodiment. The source code 50 and the program 51 correspond to each other. The program 51 is information where instructions for executing a specific process are described. The program 51 of this example includes a plurality of instruction codes (such as add, st, ld, jmp, cmp, jne, mov, jbr, or, and bic) indicating instruction contents and labels (such as funcA_top, funcA_if, funcA_else, Interrupt_disable, and Interrupt_enable) that specify a scope including one or more sequential instruction codes. The program 51 may further include, for example, a program counter assigned to each instruction code.

The plurality of instruction codes includes a normal instruction code 55, a critical section start instruction code (hereinafter abbreviated to start instruction code) 56, and a critical section end instruction code (hereinafter abbreviated to end instruction code) 57. The start instruction code 56 is an instruction code to execute a process of starting a critical section. The end instruction code 57 is an instruction code to execute a process of ending the critical section. The normal instruction code 55 is an instruction code other than the start instruction code 56 and the end instruction code 57.

The program 51 of this example corresponds to a function funcA of the source code 50. The normal instruction code 55 of this example includes a plurality of instruction codes to which three labels, funcA_top, funcA_if, and funcA_else, are assigned. The function funcA includes a branch process. The label funcA_top is assigned to five instruction codes (add, st, ld, st, and jmp) that do not include a branch. The label funcA_if is assigned to six instruction codes (ld, cmp, jne, mov, st, and jbr) indicating an if statement of the function funcA and its internal process. The label funcA_else is assigned to five instruction codes (ld, cmp, jne, mov, and st) indicating an else statement of the function funcA and its internal process.

A function Interrupt_disable of the source code 50 is a function to execute a critical section start process to start a critical section. The start instruction code 56 of this example includes three instruction codes (ld, or, and st) to which a label Interrupt_disable is assigned.

A function Interrupt_enable of the source code 50 is a function to execute a critical section end process to end the critical section. The end instruction code 57 of this example includes three instruction codes (ld, bic, and st) to which a label Interrupt_enable is assigned.

If there is a plurality of functions to execute the critical section start and end processes, it is preferable to be able to preset functions targeted for testing by the program information generation system 1. The functions may be specified manually by the user, or automatically by the control program's processing.

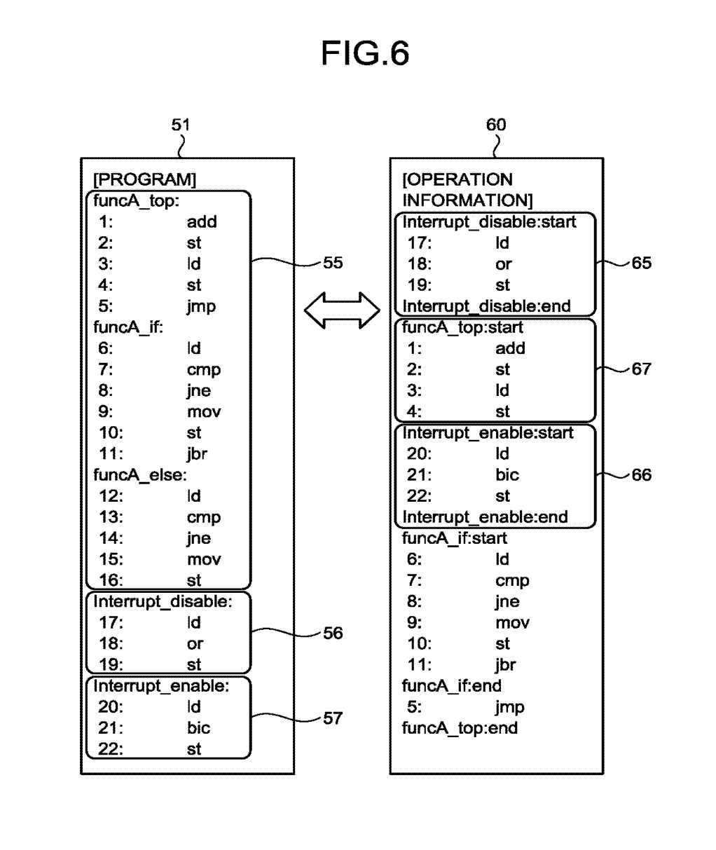

FIG. 6 is a diagram illustrating the program 51 and operation information 60 according to the first embodiment. The operation information 60 is information (an execution trace) indicating the execution order of the normal instruction code 55, the start instruction code 56, and the end instruction code 57, which are included in the program 51. In the operation information 60 of this example, a plurality of instruction codes is described in order of execution. The operation information 60 of this example is an example of a case where the critical section start and end processes have been executed with the function Interrupt_disable and the function Interrupt_enable in the process of executing the function funcA. In this example, attached labels (start and end) indicating the start and end of operation of scopes of funcA_top, funcA_if, Interrupt_disable, and Interrupt_enable are included. However, the attached labels are not necessarily required.

In FIG. 6, a critical section start location 65 (a start matching portion), a critical section end location 66 (an end matching portion), and an operation critical section 67 are illustrated in the operation information 60.

The operation critical section determination unit 21 (see FIG. 1) included in the identification unit 12 detects the critical section start location 65 that matches the critical section start instruction code 56 (ld, or, and st to which program counter values 17 to 19 are assigned) from a plurality of instruction codes included in the operation information 60. The operation critical section determination unit 21 detects the critical section end location 66 that matches the critical section end instruction code 57 (ld, bic, and st to which program counter values 20 to 22 are assigned) from a plurality of instruction codes included in the operation information 60. The operation critical section determination unit 21 determines a section between the critical section start location 65 and the critical section end location 66 to be the operation critical section 67. The identification unit 12 identifies instruction codes (add, st, ld, and st to which program counter values 1 to 4 are assigned) included in the operation critical section 67.

A method for detecting the matching portions (the critical section start location 65 and the critical section end location 66) should not be particularly limited, and is simply required to be a method using a known or novel technology as appropriate. The matching portion can be detecting by performing a searching process using, for example, the instruction codes (ld, or, and st) of the function Interrupt_disable, the instruction codes (ld, bic, and st) of the function Interrupt_enable, program counters indicating instruction codes, and labels (Interrupt_disable and Interrupt_enable) as search keywords. Moreover, the instruction codes (such as add, st, ld, jmp, cmp, jne, mov, and jbr) and the labels (such as funcA_top) of the normal instruction code 55 may be used as search keywords. With the instruction codes and labels of the normal instruction code 55 as search keywords, the arrangement order of instruction codes can be checked before and after the matching portion. Accordingly, the matching portion can be detected with higher accuracy.

In the operation information 60 of this example, the instruction codes (ld, or, and st) of the function Interrupt_disable to execute the critical section start process is before funcA_top: start being an attached label indicating the start of operation of funcA_top. From this, it can be read that the critical section start process occurred before the start of the function funcA from the operation information 60. Moreover, the instruction codes (ld, bic, and st) of the function Interrupt_enable to execute the critical section end process is after funcA_top: start, before funcA_top: end being an attached label indicating the end of operation of funcA_top, and before funcA_if: start being an attached label indicating the start of operation of funcA_if. From this, it can be read that the critical section end process occurred among the processes excluding a branch of the function funcA. Moreover, it can be read that four instruction codes add, st, ld, and st included in the function funcA have been executed in the operation critical section 67.

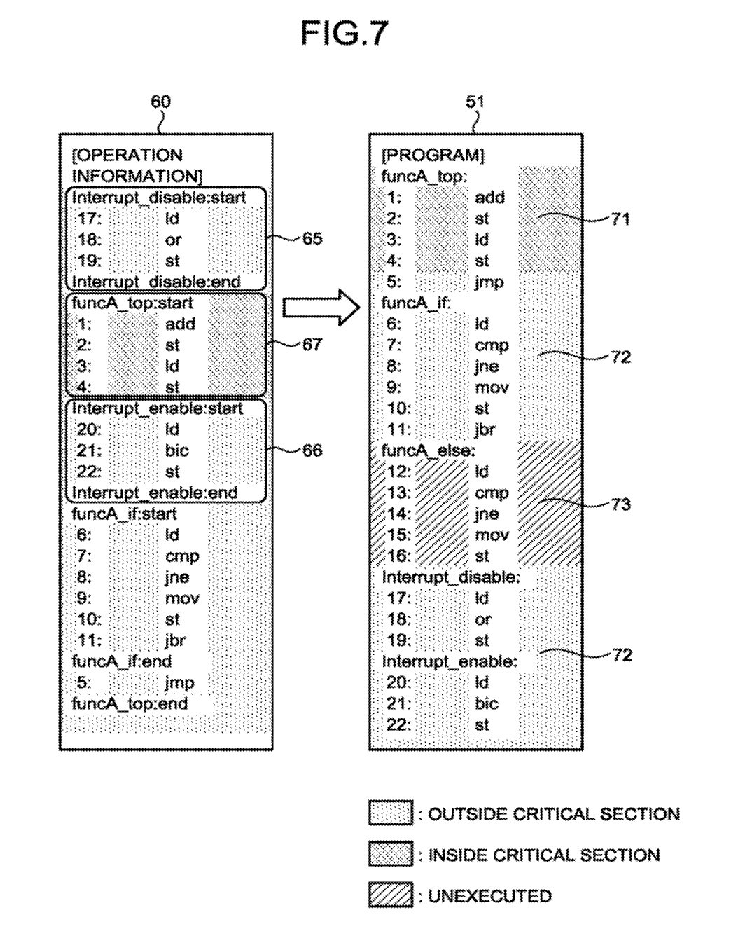

FIG. 7 is a diagram illustrating classifications of instruction codes included in the program 51 according to the first embodiment. FIG. 7 illustrates a program critical section 71, a program non-critical section 72, and an unexecuted section 73 in the program 51.

The program critical section determination unit 25 (see FIG. 1) included in the determination unit 13 determines the program critical section 71 corresponding to the operation critical section 67 on the basis of the instruction codes (add, st, ld, and st to which the program counter values 1 to 4 are assigned) included in the operation critical section 67 identified from the operation information 60. Moreover, in the embodiment, the program non-critical section 72 and the unexecuted section 73 in the program 51 are further determined.

The instruction codes (the instruction codes add, st, ld, and st to which the program counter values 1 to 4 are assigned) included in the program critical section 71 match the instruction codes included in the operation critical section 67. In other words, the instruction codes included in the program critical section 71 are instruction codes that have been executed in the critical section among all the instruction codes included in the operation information 60. The instruction codes (instruction codes to which program counter values 5 to 11 and 17 to 22 are assigned) included in the program non-critical section 72 are instruction codes that have been executed outside the critical section among all the instruction codes included in the operation information 60. The instruction codes (instruction codes to which program counter values 12 to 16 are assigned) included in the unexecuted section 73 are instruction codes that are not included in the operation information 60, that is, have not been executed. The instruction codes included in the operation information 60 are instruction codes that have been executed.

The above determination process allows the determination of which of the plurality of instruction codes included in the program 51 are included in the critical section (have been executed in the critical section). Moreover, in the embodiment, instruction codes that are not included in the critical section (have been executed outside the critical section) and unexecuted instruction codes can also be further specified.

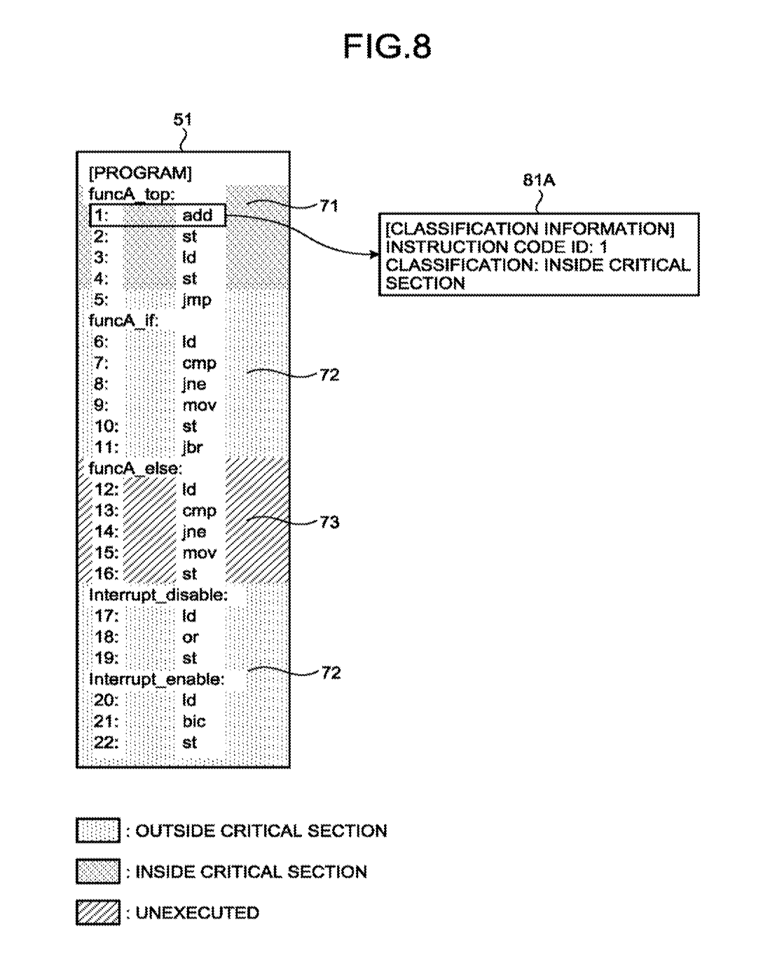

FIG. 8 is a diagram illustrating classification information 81A according to a first example of the first embodiment. The generation unit 14 (see FIG. 1) generates the classification information 81A on the basis of the result of the determination process by the determination unit 13. The classification information 81A indicates in which section (the program critical section 71, the program non-critical section 72, or the unexecuted section 73) each instruction code included in the program 51 is included (has been executed).

The classification information 81A according to this example is information on the instruction code add to which the program counter value 1 is assigned, and includes “instruction code ID” and “classification” as items. “Instruction code ID” is information that can uniquely specify an instruction code included in the program 51. In the example, the program counter value is used. However, the instruction code ID is not limited to the program counter value. “Classification” is information indicating a section including a target instruction code. The classification information 81A according to this example indicates that the instruction code add corresponding to the instruction code ID: 1 has been executed inside the critical section. Similarly, the classification information 81A indicating whether or not the instruction code has been executed outside the critical section, or has not been executed can be generated. Such classification information 81A can be generated for each instruction code. Such classification information 81A allows the grasping of a relationship between each instruction code and the critical section on the program level.

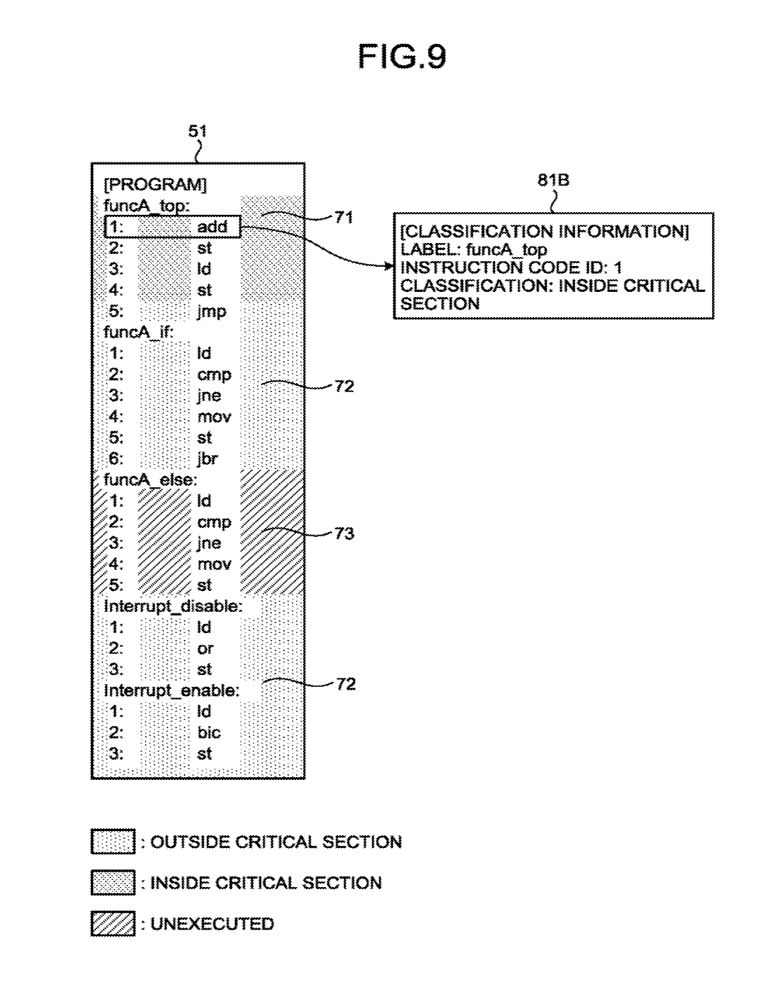

FIG. 9 is a diagram illustrating classification information 81B according to a second example of the first embodiment. The classification information 81B according to this example includes “label” as an item in addition to the items “instruction code ID” and “classification” of the classification information 81A according to the first example. “Label” is information that specifies a scope to which a target instruction code belongs. In this manner, information on an instruction code is added as appropriate; accordingly, the convenience of the information can be improved.

According to the embodiment, the classification information 81A and 81B that determines in which section (inside the critical section, outside the critical section, or unexecuted) each instruction code included in the program 51 is included can be generated. Consequently, information on the critical section can be acquired on the program level, and useful information can be provided to the user.

Other embodiments are described below with reference to the drawings. However, the same reference numerals are assigned to parts that have the same or similar operations and effects as those of the first embodiment to omit their descriptions.

### Second Embodiment

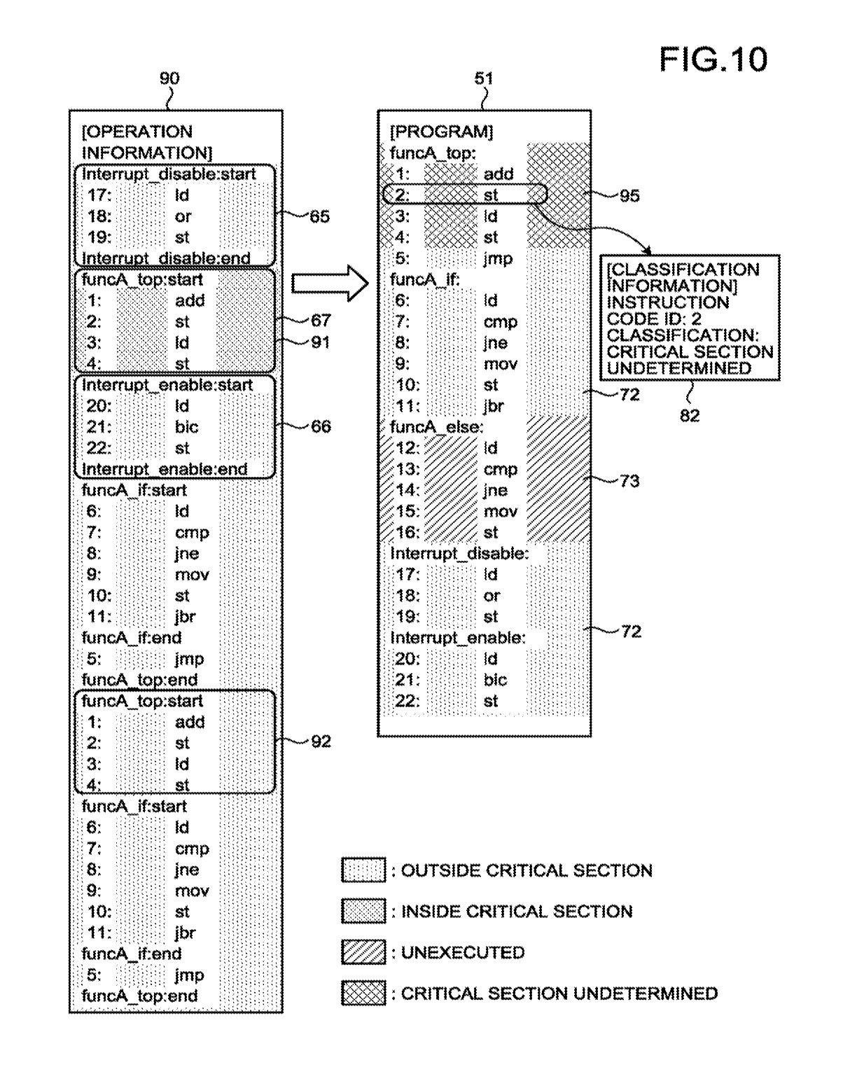

FIG. 10 is a diagram illustrating classifications of instruction codes included in the program 51 and classification information 82 according to a second embodiment. In operation information 90 according to the embodiment, each of instruction codes to which the program counter values 1 to 11 are assigned have been executed twice. Among these instruction codes, a first instruction code group 91 to which the program counter values 1 to 4 are assigned, which were executed first, is included in the operation critical section 67. A second instruction code group 92 to which the program counter values 1 to 4 are assigned, which were executed later, is not included in the operation critical section 67.

As described above, in the embodiment, the same scope (the scope including the instruction code group add, st, ld, and st to which the program counter values 1 to 4 are assigned) in the program 51 has been executed both inside and outside the critical section. The generation unit 14 according to the embodiment classifies the instruction code that has been executed both inside and outside the critical section in this manner into an undetermined section 95. The classification information 82 according to the embodiment is information on the instruction code st to which the program counter value 2 is assigned, and its “classification” is “critical section undetermined.” This classification indicates that a target instruction code has been executed both inside and outside the critical section.

In this manner, the classification indicating the case of execution both inside and outside the critical section is added to enable generation of more detailed classification information 82.

### Third Embodiment

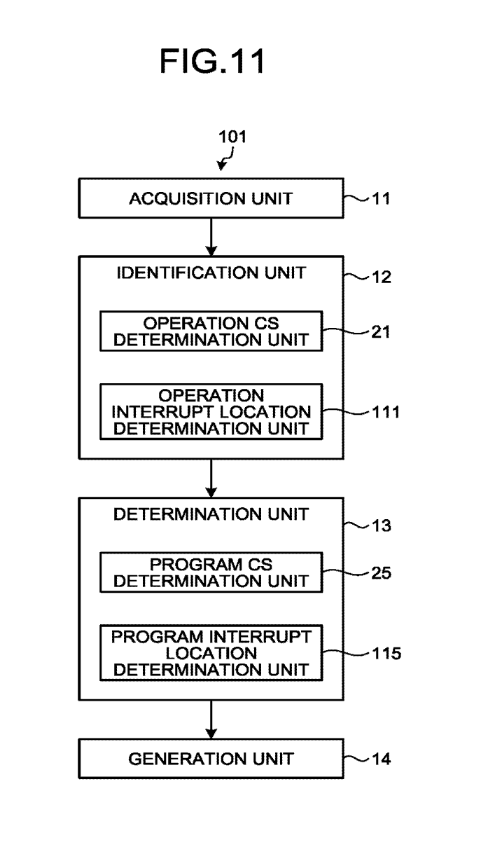

FIG. 11 is a diagram illustrating a functional configuration of a program information generation system 101 according to a third embodiment. In a functional configuration comparison with the program information generation system 1 according to the first embodiment, which is illustrated in FIG. 1, the identification unit 12 of the program information generation system 101 according to the embodiment further includes an operation interrupt location determination unit 111. The determination unit 13 further includes a program interrupt location determination unit 115.

The program acquired by the acquisition unit 11 according to the embodiment includes an interrupt instruction code to execute an interrupt process. The operation interrupt location determination unit 111 determines the location of occurrence of an interrupt on the operation information level. The program interrupt location determination unit 115 determines the location of occurrence of an interrupt on the program level. The generation unit 14 generates classification information also including information on the interrupt process in addition to the information on the critical section.

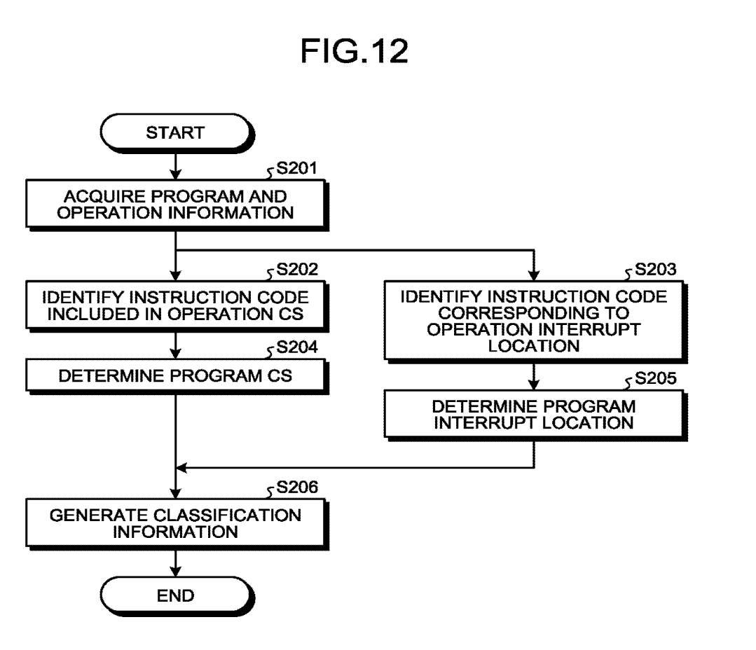

FIG. 12 is a flowchart illustrating the flow of processes of the program information generation system 101 according to the third embodiment. Firstly, the acquisition unit 11 acquires the program and the operation information (S201). The identification unit 12 then determines the operation critical section 67 with the function of the operation critical section determination unit 21, and identifies an instruction code included in the operation critical section 67 from the operation information (S202). Subsequently or concurrently with step S202, the identification unit 12 determines an operation interrupt location (first location) being the location of occurrence of an interrupt on the operation information level with the function of the operation interrupt location determination unit 111, and identifies an instruction code corresponding to the operation interrupt location (S203). The determination unit 13 then determines the program critical section 71 with the function of the program critical section determination unit 25 (S204). Subsequently or concurrently with step S204, the determination unit 13 determines a program interrupt location (second location) being the location of occurrence of an interrupt on the program level on the basis of the instruction code identified in step S203 with the function of the program interrupt location determination unit 115 (S205). The generation unit 14 then generates classification information on the basis of the program critical section 71 and the program interrupt location (S206).

The above configuration allows the generation of the classification information including program-level information on the critical section and the interrupt location.

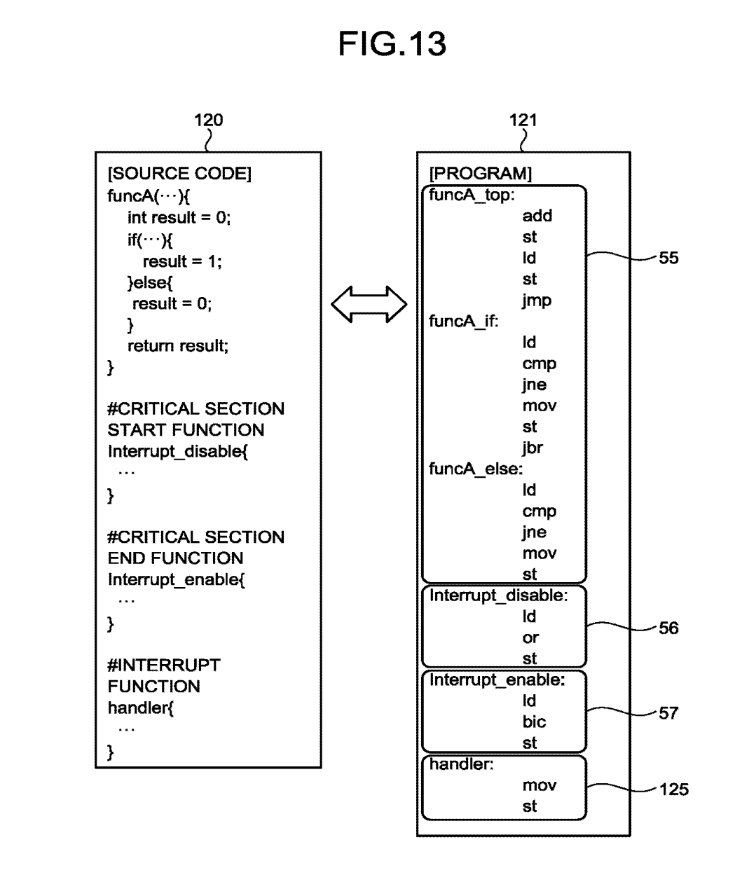

FIG. 13 is a diagram illustrating a source code 120 and a program 121 according to the third embodiment. An interrupt function handler included in the source code 120 is a function to execute an interrupt process. An interrupt instruction code 125 corresponding to the interrupt function handler, which is included in the program 121, includes a plurality of instruction codes (mov and st) to which a label handler is assigned.

If there is a plurality of interrupt functions, it is preferable to be able to previously specify a function targeted for testing by the program information generation system 101. The function may be specified manually by the user, or automatically by the control program's processing.

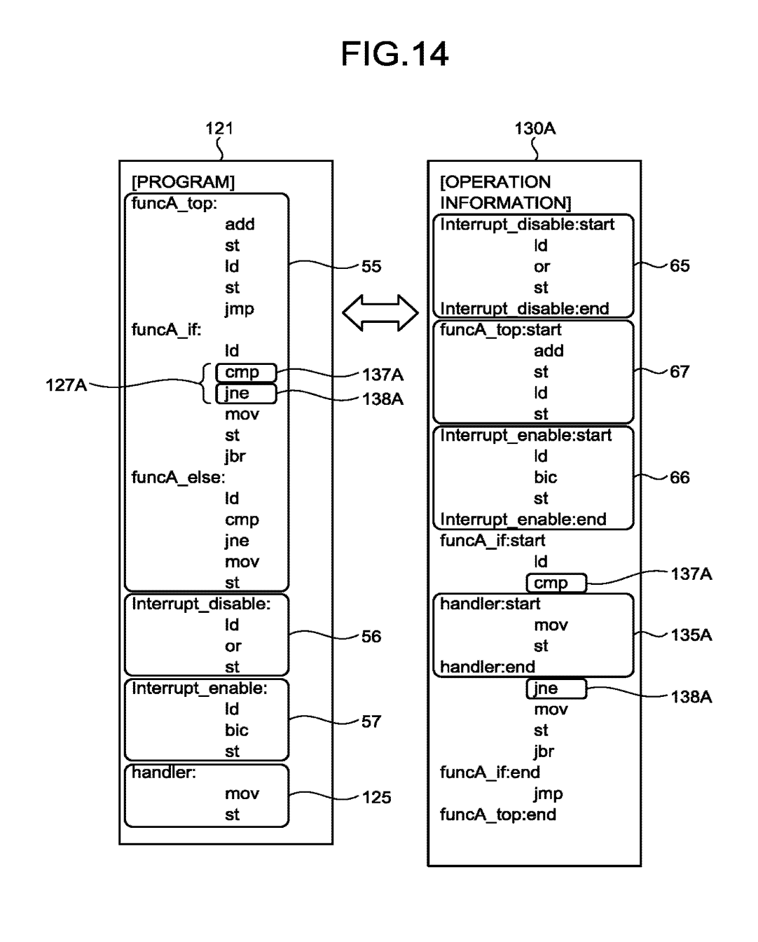

FIG. 14 is a diagram illustrating the program 121 and operation information 130A according to the third embodiment. The operation information 130A is information indicating an execution order of the normal instruction code 55, the start instruction code 56, the end instruction code 57, and the interrupt instruction code 125, which are included in the program 121. The operation information 130A is an example of a case where an interrupt process is executed by the interrupt function handler during execution of the function funcA. The operation information 130A according to this example includes attached labels (start and end) indicating the start and end of operation of each scope of funcA_top, funcA_if, Interrupt_disable, Interrupt_enable, and handler. However, the attached labels are not necessarily required.

In the operation information 130A, the critical section start location 65, the critical section end location 66, the operation critical section 67, and an operation interrupt location 135A are illustrated. The instruction code (cmp) executed immediately before the operation interrupt location 135A is referred to as the immediately preceding instruction code 137A. The instruction code (jne) executed immediately after the operation interrupt location 135A is referred to as the immediately following instruction code 138A. The immediately preceding instruction code 137A and the immediately following instruction code 138A are instruction codes corresponding to the operation interrupt location 135A.

The operation interrupt location determination unit 111 according to the embodiment determines a portion that matches the instruction codes (mov and st) included in the interrupt instruction code 125 (an interrupt matching portion) in the operation information 130A to be the operation interrupt location 135A. The identification unit 12 identifies, from the operation information 130A, the immediately preceding instruction code (cmp) 137A and the immediately following instruction code (jne) 138A corresponding to the operation interrupt location 135A determined in this manner. The program interrupt location determination unit 115 according to the embodiment determines a portion where the immediately preceding instruction code 137A and the immediately following instruction code 138A are sequential in the program 121 to be a program interrupt location 127A.

A method for detecting the matching portion (the operation interrupt location 135A) should not be particularly limited, and is simply required to be a method using a known or novel technology as appropriate. The matching portion can be detected from the operation information 130A using, for example, the interrupt instruction codes (mov and st) and the label (handler) as search keywords. Moreover, the normal instruction code 55, the start instruction code 56, the end instruction code 57, and the label may be used as search keywords. The normal instruction code 55, the start instruction code 56, the end instruction code 57, and the label are used as search keywords to enable a check for the arrangement order of the immediately preceding instruction code 137A and the immediately following instruction code 138A. Accordingly, the matching portion can be detected with higher accuracy.

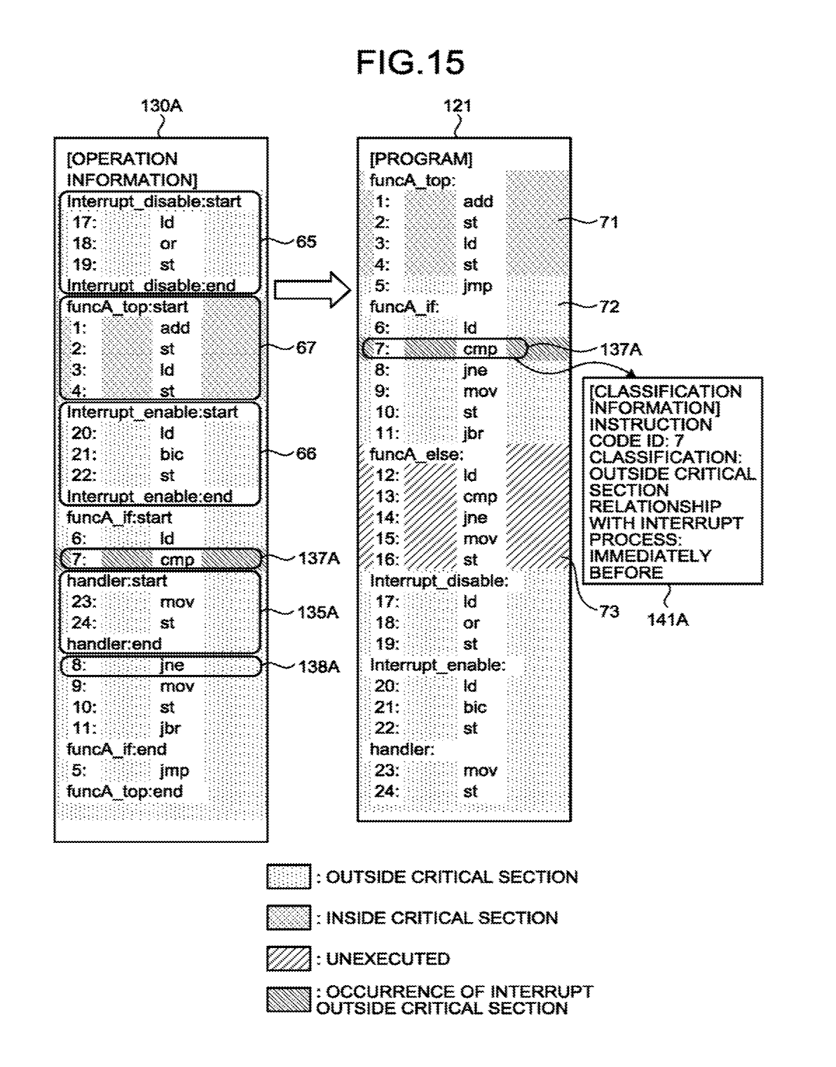

FIG. 15 is a diagram illustrating classifications of instruction codes included in the program 121 and classification information 141A, according to a first example of the third embodiment. This example is an example of a case where an interrupt process occurred outside the critical section. The immediately preceding instruction code 137A in the operation information 130A and the program 121 according to this example is the instruction code cmp to which the program counter value 7 is assigned, and is included in the program non-critical section 72. In other words, it indicates that the interrupt process occurred outside the critical section immediately after the execution of the instruction code cmp to which the program counter value 7 is assigned.

The generation unit 14 according to the embodiment generates the classification information 141A including the information on the interrupt process that has been determined as described above. The classification information 141A includes information indicating in which section (inside the critical section (the program critical section 71), outside the critical section (the program non-critical section 72), or unexecuted (the unexecuted section 73)) each instruction code included in the program 121 is included, and information indicating a relationship with the interrupt process.

The classification information 141A according to this example is information on the instruction code cmp to which the program counter value 7 is assigned, and includes “instruction code ID,” “classification,” and “relationship with interrupt process” as items. “Instruction code ID” and “classification” are similar to those of the first embodiment. “Relationship with interrupt process” is information indicating the relationship between the execution timing of a target instruction code and the execution timing of the interrupt process. In this example, “instruction code ID” is “7”, “classification” is “outside critical section,” and “relationship with interrupt process” is “immediately before.” “Relationship with interrupt process”: “immediately before” indicates that the target instruction code (cmp) was executed immediately before the occurrence of the interrupt process. “Relationship with interrupt process” according to this example is information indicating whether the target instruction code is immediately before or immediately after the location of occurrence of the interrupt, or at some other location. “Relationship with interrupt process,” however, is not limited to them. Such classification information 141A allows the gasping of the relationship between each instruction code, the critical section, and the interrupt process on the program level.

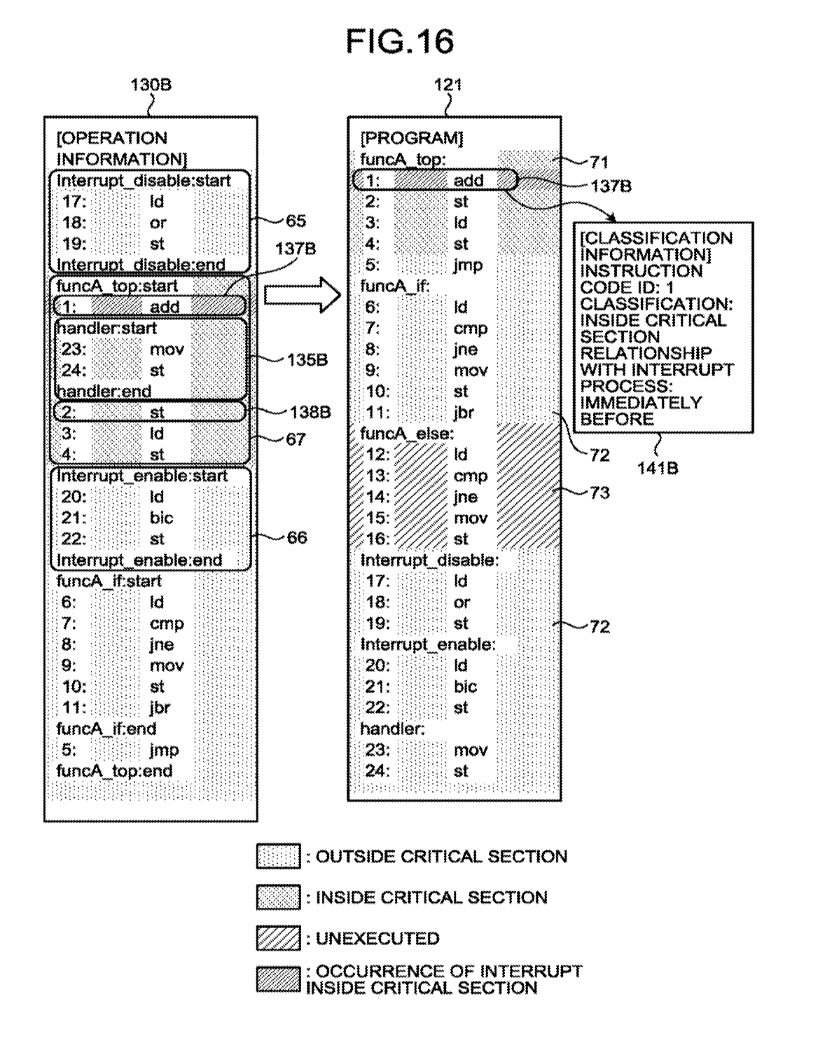

FIG. 16 is a diagram illustrating classifications of instruction codes included in the program 121 and classification information 141B according to a second example of the third embodiment. This example is an example of a case where an interrupt process occurred in the critical section. An immediately preceding instruction code 137B in operation information 130B and the program 121 according to this example is the instruction code add to which the program counter value 1 is assigned, and is included in the program critical section 71. In other words, it indicates that the interrupt process occurred inside the critical section immediately after the execution of the instruction code add to which the program counter value 1 is assigned.

The classification information 141B according to this example is information on the instruction code add to which the program counter value 1 is assigned. “Instruction code ID” is “1”, “classification” is “inside critical section,” and “relationship with interrupt process” is “immediately before.” Such classification information 141B allows easy finding of an instruction code closely related to an interrupt process that occurred inside the critical section where an interrupt process should not originally occur, that is, an instruction code that is highly likely to require an improvement.

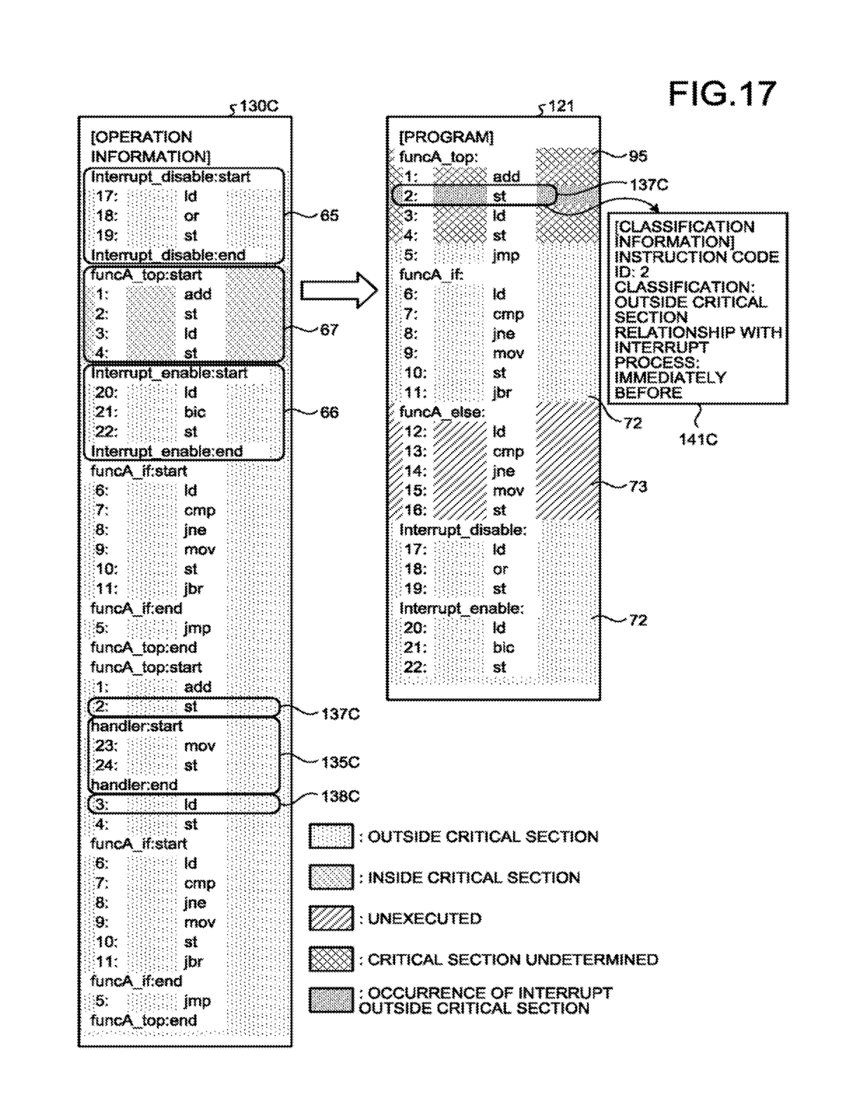

FIG. 17 is a diagram illustrating classifications of instruction codes included in the program 121 and classification information 141C according to a third example of the third embodiment. This example is an example of a case where an interrupt process occurred immediately after an instruction code executed in the critical section undetermined region, that is, both inside and outside the critical section. An immediately preceding instruction code 137C in operation information 130C and the program 121 according to this example is the instruction code st to which the program counter value 2 is assigned, and is included in the undetermined section 95. In other words, it indicates that the interrupt process occurred immediately after the execution of the instruction code st to which the program counter value 2 is assigned, the instruction code st having been executed both inside and outside the critical section.

The classification information 141C according to this example is information on the instruction code st to which the program counter value 2 is assigned. “Instruction code ID” is “2”, “classification” is “critical section undetermined,” and “relationship with interrupt process” is “immediately before.” With such classification information 141C, it becomes possible to recognize that an instruction code closely related to an interrupt process has been executed both inside and outside the critical section.

As describe above, according to the embodiment, information on the critical section and information on an interrupt process can be acquired on the program level.

In the first to third embodiments, the plurality of types of classification information 81A, 81B, 82, and 141A to 141C is illustrated. However, classification information generated by the generation unit 14 is not limited to these types of information. The classification information may be information where information has been added, deleted, or modified appropriately. Examples of the possible information to be added appropriately include the number of times of occurrence of an interrupt process, the execution time of each process (scope), and a parent-child relationship (a call relationship) between each process (scope).

The classification information 81A, 81B, 82, and 141A to 141C (including information derived from them) generated as described above can be used for various purposes. The classification information 81A, 81B 82, and 141A to 141C may visualize the execution status of the program 51 using, for example, a GUI (Graphical User Interface), may be provided to a system that, for example, verifies the program 51 (the source code 50), or may be output as it is to, for example, a display of a computer.

The hardware configurations illustrated in FIGS. 2 and 3 are examples. The program information generation system 1 can be implemented by various hardware configurations. For example, the program information generation system 1 may be configured by a single general-purpose computer, a dedicated apparatus including a built-in processor, or the like.

Moreover, FIG. 1 illustrates the configuration where the acquisition unit 11, the identification unit 12, the determination unit 13, and the generation unit 14, which are the most basic function blocks of the program information generation system 1, are connected in order of processing. However, the embodiments are not limited to this configuration. For example, the configuration may be one where each function block operates in parallel while in cooperation, one where function blocks change their places, one where one function block is divided into a plurality of function blocks, or a combination of the above three configurations.

The control program to implement the functions of the program information generation system 1 can be recorded and provided in a file of an installable or executable format in a computer-readable recording medium such as a CD-ROM, flexible disk (FD), CD-R, or DVD. Moreover, the control program may be provided by being downloaded from a predetermined storage apparatus connected to a network to a predetermined computer, or may be preinstalled in the ROM or the like to be provided to a predetermined information processing apparatus. Moreover, the control program may be configured by a plurality of modules that implement the functions of the acquisition unit 11, the identification unit 12, the determination unit 13, and the generation unit 14.

### Fourth Embodiment

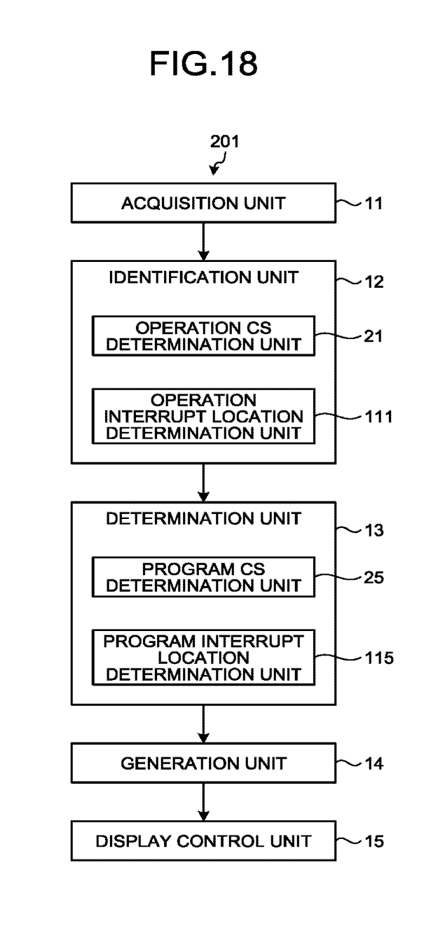

FIG. 18 is a diagram illustrating a functional configuration of a program information generation system 201 according to a fourth embodiment. The program information generation system 201 according to the embodiment includes a display control unit 15 in addition to the configuration of the program information generation system 101 according to the third embodiment illustrated in FIG. 11.

The display control unit 15 controls a predetermined display unit in such a manner as to display a display image indicating the relationship between an instruction code and the critical section, the relationship between an instruction code, the critical section, and an interrupt process, and the like on the basis of the classification information 81A, 81B, 82, 141A, 141B, or 141C generated by the generation unit 14, or information where information has been added appropriately to the classification information. The display unit is a device that outputs images, and is, for example, a display and a printer. The display control unit 15 is configured using, for example, the CPU 41, the control program, the logic IC, and the RAM 43.

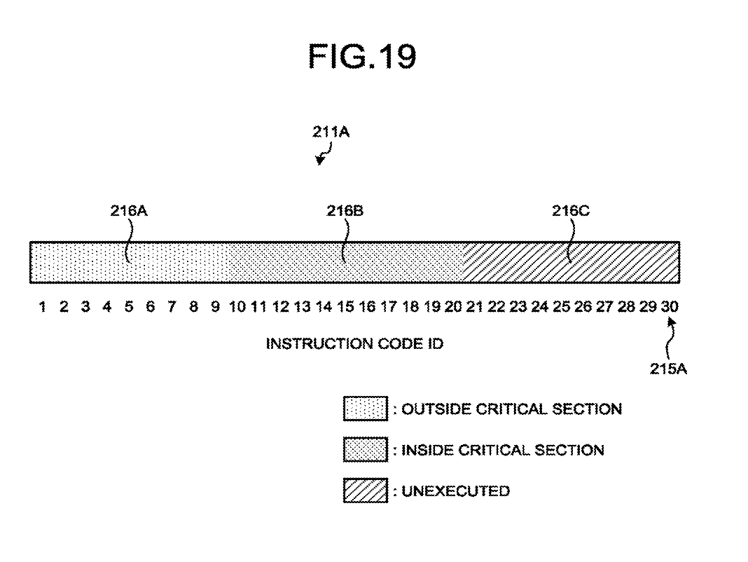

FIG. 19 is a diagram illustrating a display image 211A according to a first example of the fourth embodiment. The display image 211A according to this example includes an instruction code object 215A and section objects 216A to 216C.

The instruction code object 215A is an object that specifies each instruction code included in the program 51, 121. In this example, the instruction code object 215A indicates an instruction code ID (program counter value). The section objects 216A to 216C indicate the type of a section to which each instruction code belongs. The section object 216A indicates outside the critical section (the program non-critical section 72). The section object 216B indicates inside the critical section (the program critical section 71). The section object 216C indicates unexecuted (the unexecuted section 73). Display modes (for example, color, luminance, shading, hatching, and blinking) of the section objects 216A to 216C are different from each other to make the types of the sections visually recognizable. Such a display image 211A allows accurate grasping of a section to which each instruction code included in the program 51, 121 belongs.

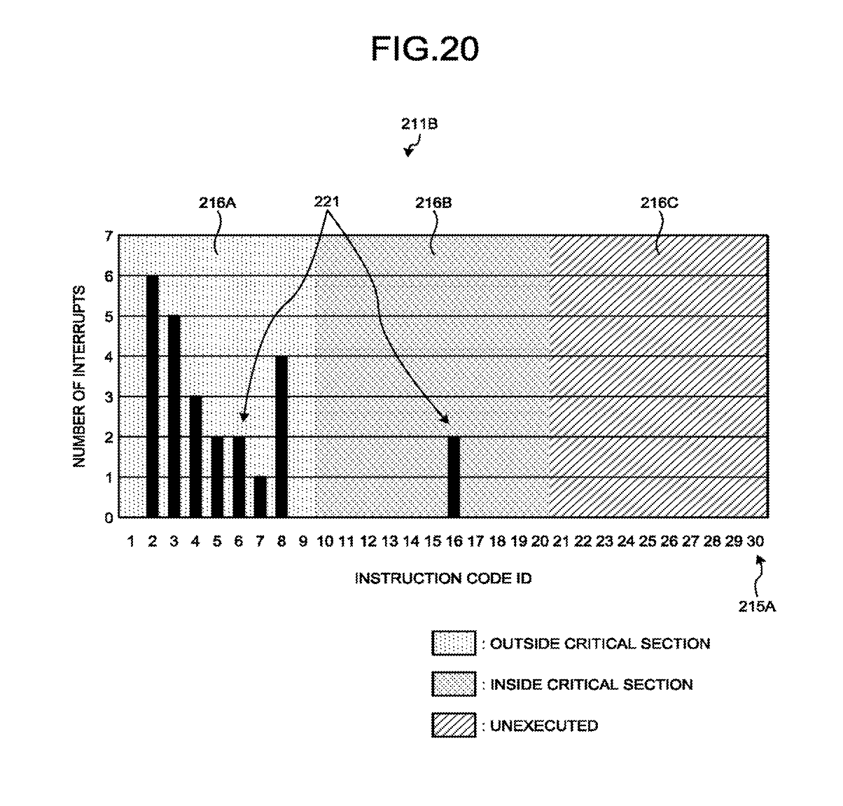

FIG. 20 is a diagram illustrating a display image 211B according to a second example of the fourth embodiment. The display image 211B according to this example includes an interrupt count object 221 in addition to the configuration of the display image 211A according to the first example illustrated in FIG. 19.

The interrupt count object 221 indicates the number of interrupt processes that occurred immediately after the execution of each instruction code. The interrupt count object 221 may indicate the number of interrupt processes that occurred immediately before the execution of each instruction code. Such a display image 211B allows accurate grasping of the relationship between the frequency of occurrence of an interrupt process and an instruction code, the occurrence of an interrupt process inside the critical section, and the like.

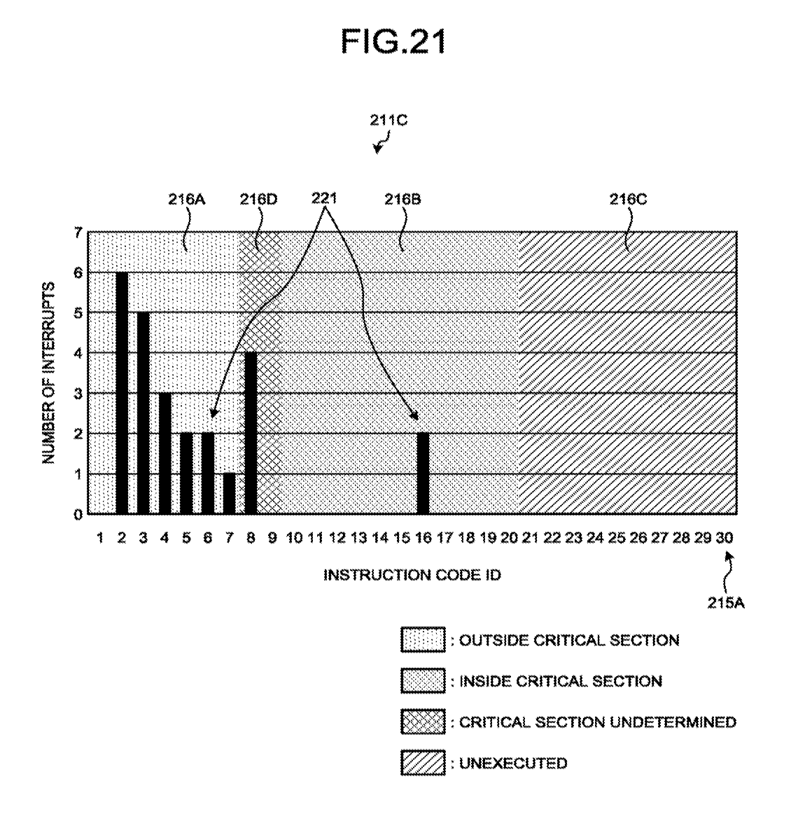

FIG. 21 is a diagram illustrating a display image 211C according to a third example of the fourth embodiment. The display image 211C according to this example includes a section object 216D indicating critical section undetermined (the undetermined section 95), in addition to the configuration of the display image 211B according to the second example illustrated in FIG. 20. Such a display image 211C allows accurate grasping of the status of an instruction code that has been executed both inside and outside the critical section.

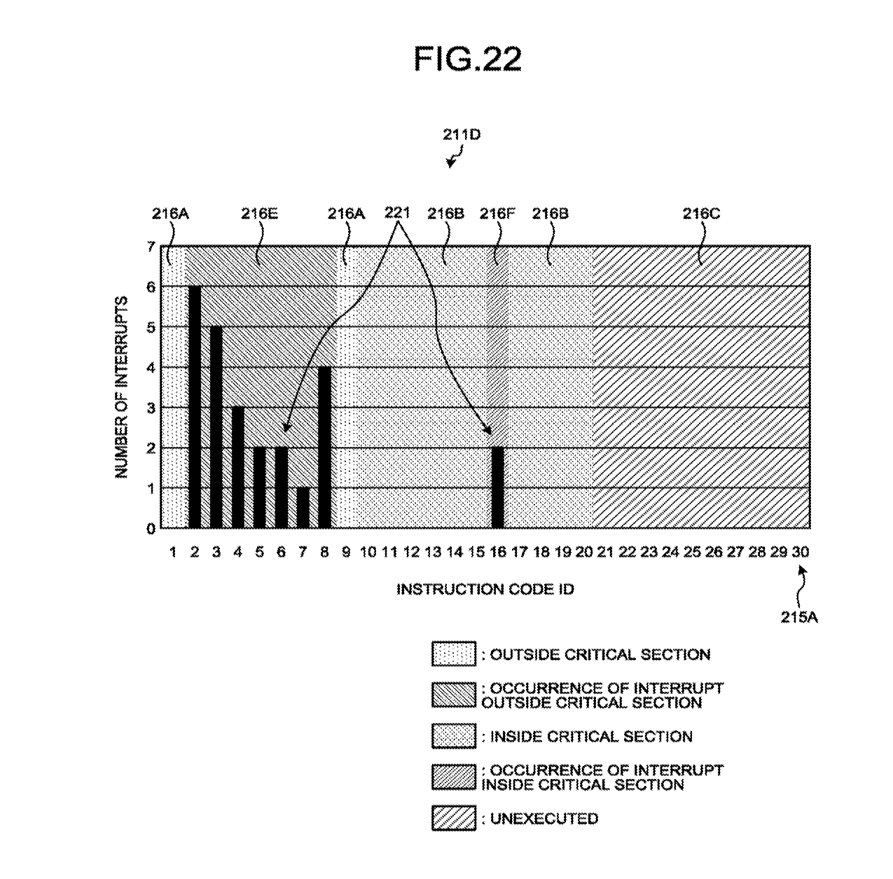

FIG. 22 is a diagram illustrating a display image 211D according to a fourth example of the fourth embodiment. The display image 211D according to this example includes a section object 216E indicating a portion where an interrupt process has occurred outside the critical section, and a section object 216F indicating a portion where an interrupt process has occurred inside the critical section, in addition to the configuration of the display image 211B according to the second example illustrated in FIG. 20. Such a display image 211D allows more accurate grasping of the relationship between the critical section and an interrupt process.

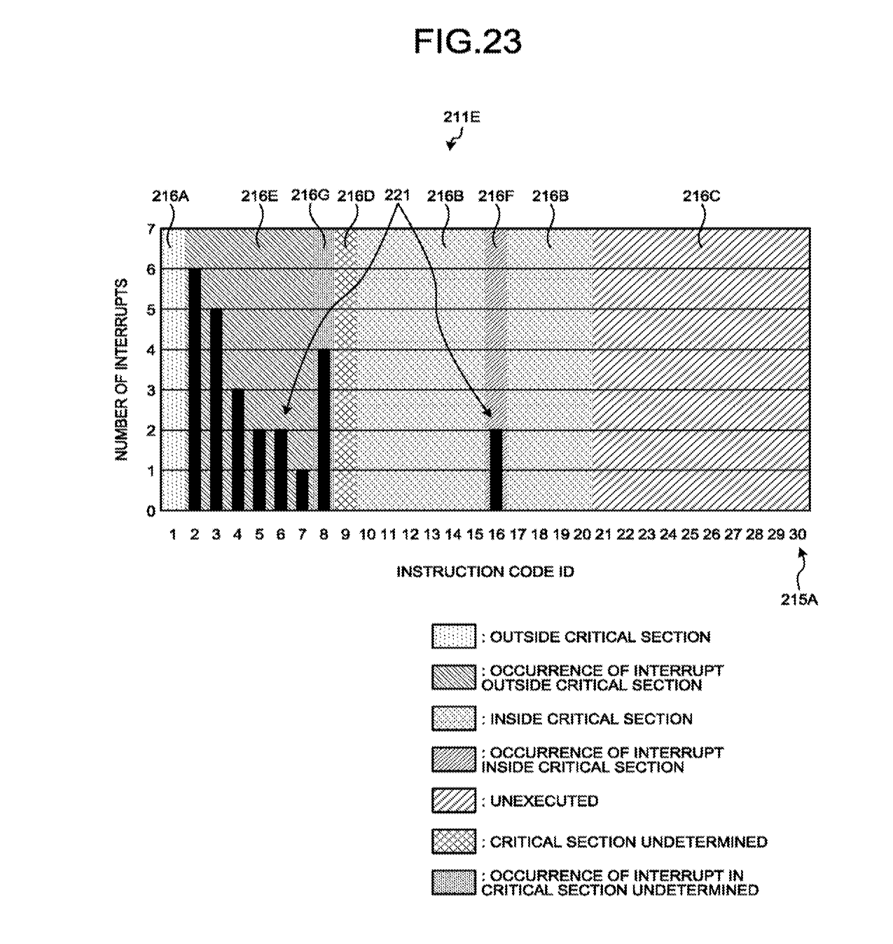

FIG. 23 is a diagram illustrating a display image 211E according to a fifth example of the fourth embodiment. The display image 211E according to this example includes the section object 216D indicating critical section undetermined (the undetermined section 95), and a section object 216G indicating a portion where an interrupt process has occurred inside critical section undetermined, in addition to the configuration of the display image 211D according to the fourth example illustrated in FIG. 22. Such a display image 211E allows accurate grasping of the relationship between an instruction code executed both inside and outside the critical section, and an interrupt process.

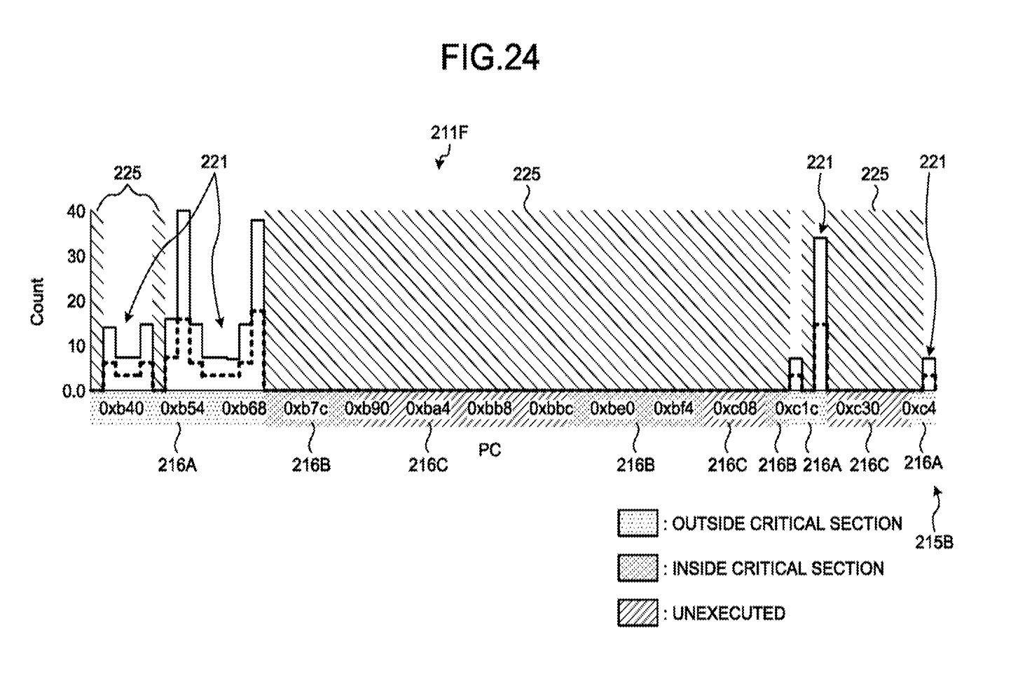

FIG. 24 is a diagram illustrating a display image 211F according to a sixth example of the fourth embodiment. The display image 211F according to this example includes similar section objects 216A to 216C and interrupt count object 221 to those of the display image 211B according to the second example illustrated in FIG. 20. An instruction code object 215B according to this example is displayed in hexadecimal. Such a display may be used instead of the program counter value. Moreover, the display image 211F according to this example includes an interrupt unoccurred object 225. The interrupt unoccurred object 225 is displayed corresponding to an instruction code for which an interrupt process did not occur immediately after its execution. Such a display image 211F allows more accurate grasping of the relationship between an instruction code and an interrupt process.

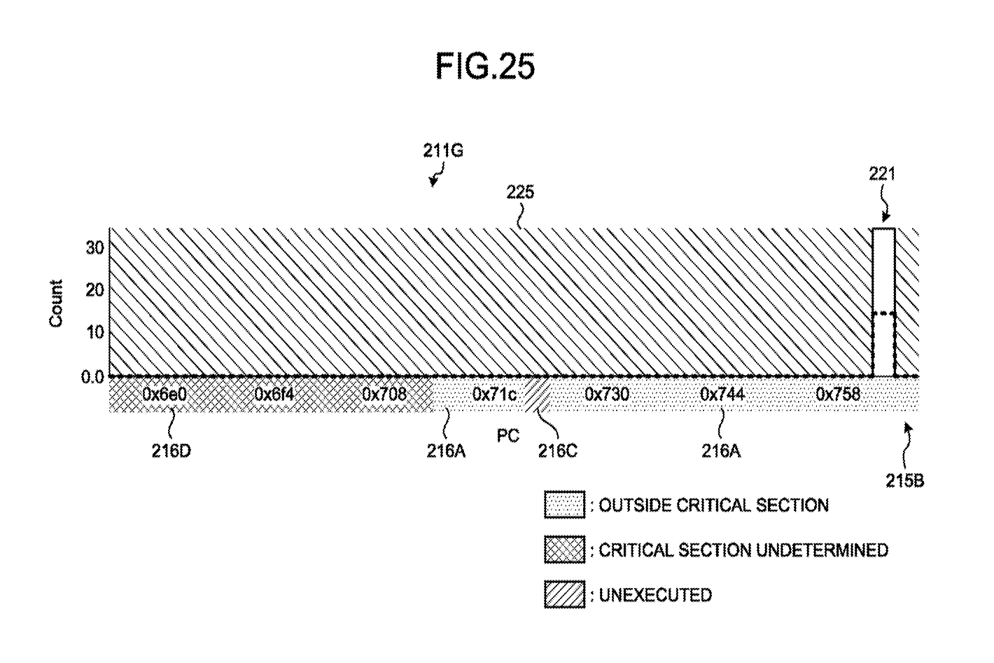

FIG. 25 is a diagram illustrating a display image 211G according to a seventh example of the fourth embodiment. The display image 211G according to this example does not include the section object 216B indicating inside the critical section and includes the section object 216D indicating critical section undetermined. Such a display image 211G also allows grasping of the relationship between an instruction code, the critical section, and an interrupt process.

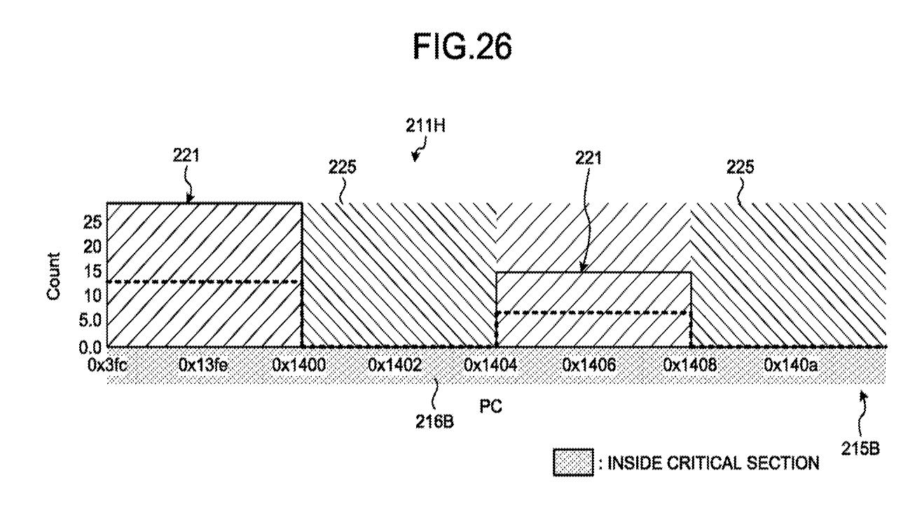

FIG. 26 is a diagram illustrating a display image 211H according to an eighth example of the fourth embodiment. The display image 211H according to this example includes only the section object 216B indicating inside the critical section as an object indicating the type of a section, and includes the interrupt count object 221 and the interrupt unoccurred object 225. In this manner, only the state of a specific section can be displayed. Accordingly, the specific section can be verified more intensively.

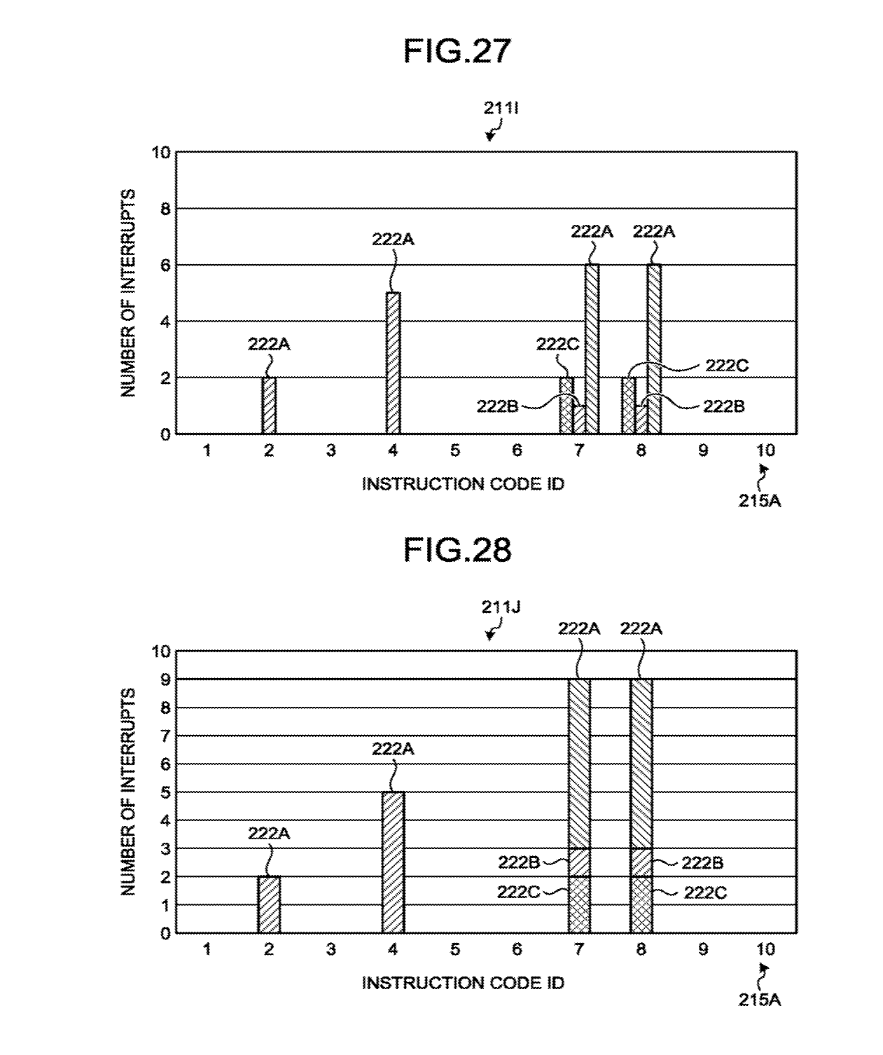

FIG. 27 is a diagram illustrating a display image 211I according to a ninth example of the fourth embodiment. The display image 211I according to this example does not include similar objects to the section objects 216A to 216G according to the first to eighth examples. The display image 211I according to this example includes interrupt count objects 222A to 222C indicating an interrupt process according to the types of sections, as objects indicating the number of interrupts. In this example, the plurality of interrupt count objects 222A to 222C corresponding to the same instruction code is displayed in parallel (see instruction code ID: 7 and 8). For example, the interrupt count object 222A indicates the number of interrupts outside the critical section. The interrupt count object 222B indicates the number of interrupts inside the critical section. The interrupt count object 222C indicates the number of interrupts in the undetermined section 95. Such a display image 211I also allows accurate grasping of the relationship between an instruction code, the critical section, and an interrupt process.

FIG. 28 is a diagram illustrating a display image 211J according to a tenth example of the fourth embodiment. The display image 211J according to this example includes similar interrupt count objects 222A to 222C to those of the ninth example illustrated in FIG. 27. In this example, the plurality of interrupt count objects 222A to 222C corresponding to the same instruction code is displayed in series (see instruction code ID: 7 and 8). Such a display image 211J also allows accurate grasping of the relationship between an instruction code, the critical section, and an interrupt process.

While certain embodiments have been described, these embodiments have been presented by way of example only, and are not intended to limit the scope of the inventions. Indeed, the novel systems, methods, and computer program products described herein may be embodied in a variety of other forms; furthermore, various omissions, substitutions and changes in the form of the systems, methods, and computer program products described herein may be made without departing from the spirit of the inventions. The accompanying claims and their equivalents are intended to cover such forms or modifications as would fall within the scope and spirits of the inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program information generation system comprising circuitry configured to:
acquire a program and operation information, the program including a plurality of instruction codes including a start instruction code for starting a critical section where an interrupt process is disabled and an end instruction code for ending the critical section, the operation information indicating an execution order of the plurality of instruction codes;
identify the instruction code included in a first section corresponding to the critical section from the operation information, on the basis of the start instruction code, the end instruction code, and the operation information;
determine a second section, corresponding to the first section, within the program on the basis of the instruction code included in the first section; and
generate classification information for allowing specification of the instruction code included in the critical section or the instruction code included in a non-critical section being a section other than the critical section, on the basis of the second section.

2. The program information generation system according to claim 1, wherein the classification information allows specification of both of the instruction code included in the critical section and the instruction code included in the non-critical section.

3. The program information generation system according to claim 1, wherein the circuitry is further configured to:
detect a start matching portion that matches the start instruction code and an end matching portion that matches the end instruction code from the plurality of instruction codes included in the operation information;
determine a section between the start matching portion and the end matching portion to be the first section; and
determine a section, matching a sequence of one or more instruction codes included in the first section, within the program to be the second section.

4. The program information generation system according to claim 1, wherein
the program further includes an interrupt instruction code for executing the interrupt process, and
the circuitry is further configured to:
identify the instruction code corresponding to a first location indicating a location of occurrence of the interrupt process from the operation information, on the basis of the interrupt instruction code and the operation information;
determine a second location, corresponding to the first location, within the program, on the basis of the instruction code corresponding to the first location; and
generate the classification information further allows determination of whether or not the critical section includes the location of occurrence of the interrupt process, on the basis of the second location and the second section.

5. The program information generation system according to claim 4, wherein the circuitry is further configured to:
detect an interrupt matching portion that matches the interrupt instruction code from the plurality of instruction codes included in the operation information;
detect an immediately preceding instruction code located immediately before the interrupt matching portion and an immediately following instruction code located immediately after the interrupt matching portion; and
determine a portion where the immediately preceding instruction code and the immediately following instruction code are sequential among the plurality of instruction codes included in the program to be the second location.

6. The program information generation system according to claim 1, wherein the circuitry is further configured to control a display unit in such a manner as to display a display image indicating a relationship between the instruction code and the critical section, on the basis of the classification information.

7. The program information generation system according to claim 4, wherein the circuitry is further configured to control a display unit in such a manner as to display a display image indicating a relationship between the instruction code, the critical section, and the location of occurrence of the interrupt process, on the basis of the classification information.

8. A program information generation method comprising:
acquiring a program and operation information, the program including a plurality of instruction codes including a start instruction code for starting a critical section where an interrupt process is disabled and an end instruction code for ending the critical section, the operation information indicating an execution order of the plurality of instruction codes;
identifying the instruction code included in a first section corresponding to the critical section from the operation information, on the basis of the start instruction code, the end instruction code, and the operation information;
determining a second section, corresponding to the first section, within the program on the basis of the instruction code included in the first section; and
generating classification information for allowing specification of the instruction code included in the critical section or the instruction code included in a non-critical section being a section other than the critical section, on the basis of the second section.

9. A computer program product having a non-transitory computer readable medium including programmed instructions, wherein the instructions, when executed by a computer, cause the computer to perform:
acquiring a program and operation information, the program including a plurality of instruction codes including a start instruction code for starting a critical section where an interrupt process is disabled and an end instruction code for ending the critical section, the operation information indicating an execution order of the plurality of instruction codes;
identifying the instruction code included in a first section corresponding to the critical section from the operation information, on the basis of the start instruction code, the end instruction code, and the operation information;
determining a second section, corresponding to the first section, within the program on the basis of the instruction code included in the first section; and
generating classification information for allowing specification of the instruction code included in the critical section or the instruction code included in a non-critical section being a section other than the critical section, on the basis of the second section.
